(19) United States
(12) Patent Application Publication
(10) Pub. No.: US 2002/0134017 A1
(43) Pub. Date: Sep. 26, 2002

(54) Post planter

(76) Inventor: Gerald E. Gibbs, Ventura, CA (US)

Correspondence Address: Jack C. Munro, Agent of Record, Suite 225, 28720 Roadside Drive, Agoura Hills, CA, 91301, US

(21) Appl. No.: 09/813,039

(22) Filed: Mar. 21, 2001

(51) Int. Cl. A01G 9/02

(52) U.S. Cl. 47/86

(57) ABSTRACT

A post planter which is constructed of two identical parts with the parts being constructed to be located around a square shaped or rectangular post. The post planter includes an interior chamber the lower portion of which is to contain water and the upper portion of which is to contain a plant growing medium. The two parts are to be connected together by fasteners forming a single unit. There is a post receiving opening formed within the planter and this post receiving opening is size adjustable. The planter includes an annular flange located at its bottom which is to facilitate trimming of vegetation that may have grown around the planter. The top of the planter includes an elevated arcuate lip located peripherally.

### BACKGROUND OF THE INVENTION

1. Field of the Invention

The present invention relates to plant planters and more particularly to a planter that is to be mounted around a rectangular or square shaped post.

2. Description of the Related Art

It has been known, for centuries, to provide planters such as vases and pots for plants. Typically, these planters are located exteriorly or interiorly within a home or a business. The function of these planters is to provide an attractive decoration through the use of live plants.

In the past, there is used, in an outdoor environment, an umbrella with this umbrella intended to provide protection from the sun. Generally, this umbrella is mounted in conjunction with a table. Inherently, the umbrella includes a round post with this post being centrally mounted to support the umbrella. Such posts are not especially attractive. It has been common to construct a planter which is composed of two or more parts which can be placed together about the post. This planter will function to hide a portion of the post and also by including of a floral vegetation within the planter hopefully will produce a more attractive appearance than the post by itself.

However, not all posts are round. For example, mailbox posts are frequently mounted on 4×4's which are actually 3.5 inches square. There are also patio posts that are 4×6's which are 3.5 by 5.5 inches and 6×6's which are 5.5 inches square. Again, these posts have the same problem as the umbrella post in that they are not particularly attractive. It would be desirable to design some form of a planter which could be mounted about a square and rectangular post that is used to support a mailbox or used to support a patio cover.

### SUMMARY OF THE INVENTION

A post planter which includes a post shell which has an exterior surface and an interior surface. The exterior surface is arcuate, such as in the form of a half circle, and the interior surface is basically planar. Centrally formed within the interior surface is a through recess which is adapted to connect with a post. There is an enclosed chamber located between the exterior surface and the interior surface with the enclosed chamber being open at its top. The enclosed chamber is divided between a water chamber located at the bottom of the enclosed chamber and a receiving chamber for receiving plant growing medium located in the top area of the enclosed chamber. Separating the receiving chamber and the water chamber is a grate with the grate including holes that will permit the root of plants to be conducted there through and contact the water within the water chamber. A pair of these post shells are to be mounted about a post forming an enclosing single planter unit.

A further embodiment of this invention wherein the post planter has a centrally located through recess which is basically polygonal in shape.

A still further embodiment of this invention is directed to a post planter wherein the centrally located through recess is adjustable in size in order to accommodate to three different sizes of posts.

A further embodiment of post planter which includes the centrally located through recess which is adjustable in size by the inclusion of breakaway tab plates.

A further embodiment of post planter which is formed of two identical shells which are arranged in a reversed facing position.

A still further embodiment of post planter of this invention comprises a post planter which includes a water overfill hole through the sidewall of each shell that makes up the planter.

A further embodiment of post planter of this invention where each shell includes a flange which when the two shells are located in a reversed abutting position the flanges cooperate to form an annular ring which is to facilitate the trimming of vegetation that may grow in very close proximity of the base of the post planter.

A further embodiment of post planter of this invention which includes fasteners to connect together the two shells that make up the planter of this invention.

A still further embodiment of post planter of this invention is where the annular exterior wall of the planter is at a higher elevation than the interior wall surface of the shells that are located in an abutting position.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a perspective view of the post planter of this invention showing such mounted in conjunction with a conventional post that is mounted within ground;

FIG. 2 is an exploded perspective view of the two post shells that make up the post planter of the present invention;

FIG. 3 is a top plan view of the post planter constructed in accordance with this invention;

FIG. 4 is an enlarged cross-sectional view showing the fastening arrangement between the post shells of the post planter of the present invention taken along line 4-4 of FIG. 3;

FIG. 5 is a cross-sectional view through one of the breakaway tab plates utilized in conjunction with the post planter of the present invention in order to accommodate the post planter to be connected with different sizes of posts taken along line 5-5 of FIG. 6; and

FIG. 6 is a cross-sectional view through the post planter of the present invention taken along line 6-6 of FIG. 3.

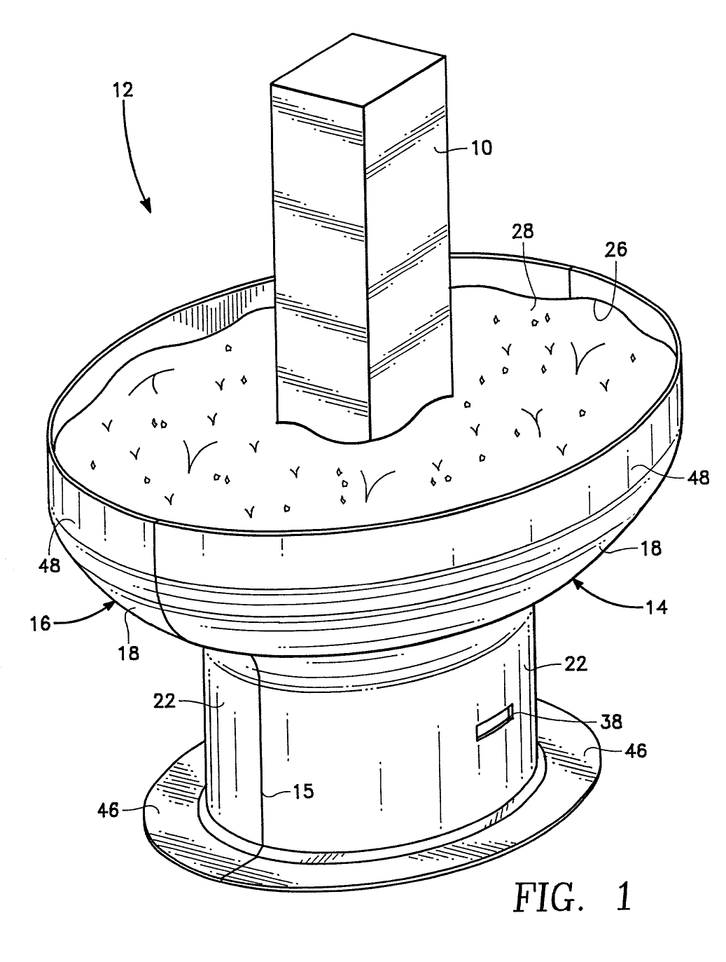

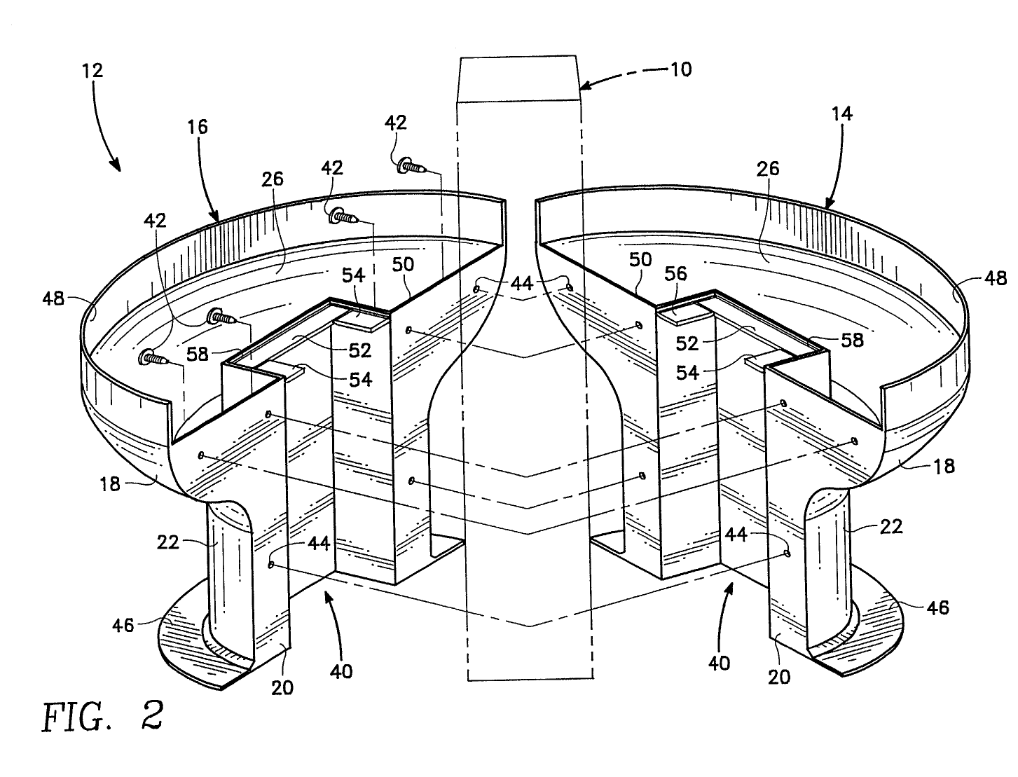

### DETAILED DESCRIPTION OF THE INVENTION

Referring particularly to the drawings, there is shown a conventional square post 10 which is to be imbedded within ground. Typically, the post 10 will be utilized to support a structure such as a mailbox, which is not shown. Mounted about the post 10 is the post planter 12 of this invention. The post planter 12 is constructed of a first post shell 14 and a second post shell 16. The post shells 14 and 16 are identical and like numerals will be used to refer to like parts.

Each post shell 14 and 16 has an exterior sidewall 18 and an interior sidewall 20. The exterior sidewall 18 includes a narrowed section 22 which is located directly adjacent the bottom wall 24. The wider portion of the exterior sidewall 18 is for the purpose in acquiring increased volume of the interior chamber 26 which is to be filled with dirt or mulch 28. The dirt or mulch 28 is to rest against a grate 30 which is in the area of the narrowed section 22. The grate 30 includes a series of holes 32. It is to be noted that the grate 30 is substantially in the shape of a half circle. Below the grate 30 is a water chamber 34. The water chamber 34 is adapted to contain a quantity of water 36. Formed within the narrowed section of the exterior sidewall 18 is a water overflow hole 38. The water 36 is to be filled within the chamber 34 until it reaches the level of the overflow hole 38. Any additional water 36 that is placed within the water chamber 34 will automatically flow exteriorly of the post planter 12 by flowing outward through each of the overflow holes 38 that are formed within each of the post shells 14 and 16.

It is to be understood that plants are to be planted within the dirt or mulch 28. These plants are to have roots, and these roots are permitted to penetrate through the holes 32 and enter into contact with the water 36 within the water chamber 34.

Therefore, the water chamber 34 can function to supply some water to the plants contained within the post planter of this invention.

The interior sidewall 20 is basically planar and includes a through recess 40. It is to be noted that each through recess 40 is basically channel shaped and has planar sidewalls and a planar back wall. When the first post shell 14 is located in a reversed abutting contact with the second post shell 16 so that the interior surfaces 20 abut one another, the through recesses 40 function to define a square shaped through hole. When the post shells 12 and 14 are so mounted together, a seam 15 is formed and the shells 12 and 14 surround the post 10 and it will normally be desirable to secure together the post shells 12 and 14. An appropriate fastener 42 is to be mounted within an aligned pair of holes 44 between the two shells 14 and 16. It is to be noted that there will be six in number of the aligned pairs of holes 44 and therefore there will also be six in number of the fasteners 42.

Located in alignment of the bottom wall 24 is a flange 46 which protrudes from the narrowed section 22. The flange 46 is of annular shape when the two post shells 14 and 16 are located in abutting contact. The function of the flange 46 is to rest upon ground and is to facilitate the trimming of any vegetation which may have a tendency to grow up against the narrowed section 22 of the post planter 12 by permitting access with a lawnmower or vegetation trimmers.

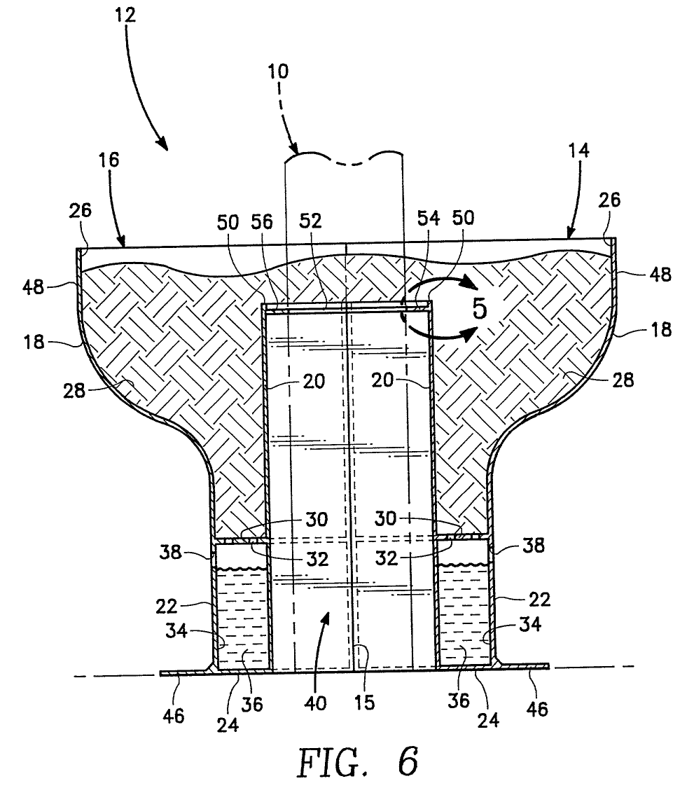

It is to be noted that the exterior sidewall 38 includes an elevated arcuate lip 48. This elevated arcuate lip 48 is of a higher elevation than the top edge 50 of the interior sidewall 20. The reason for this is that any plants that are contained within the two post shells 14 and 16 will have a tendency to grow between the post shells giving the appearance that the post planter 12 is actually constructed of a single unitary structure rather than two separate post shells 14 and 16. This growing together between the two shells is permitted by the fact that the dirt or mulch 28 is placed higher than the top edge 50 and covers such, as is clearly shown in FIG. 6 of the drawings.

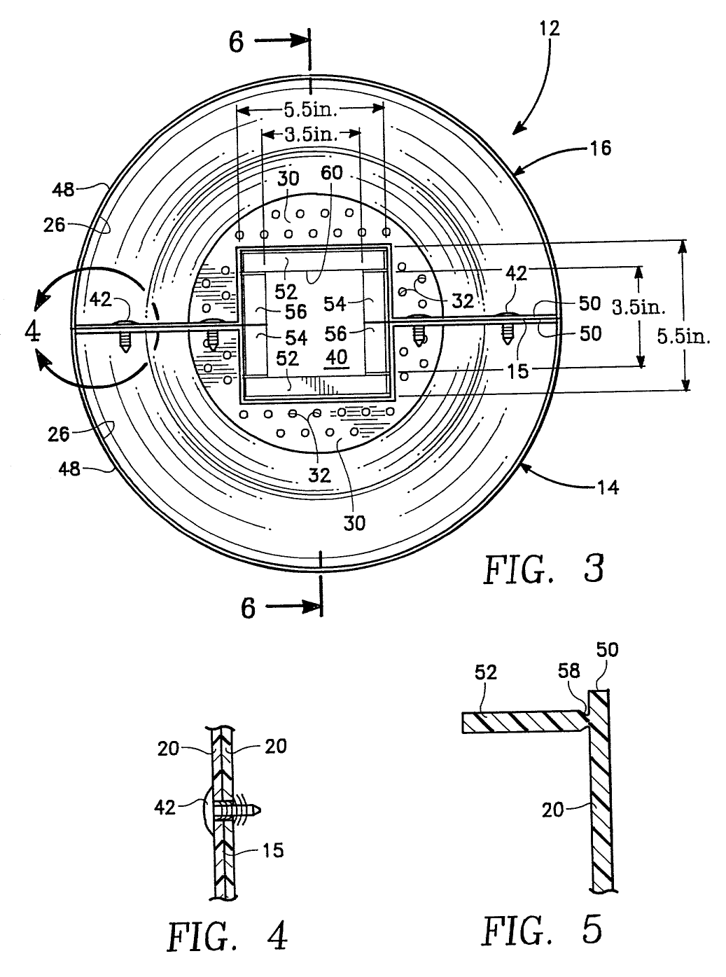

Directly adjacent the top edge 50 there is integrally formed with the through recess 40 a breakaway back plate 52 and breakaway side plates 54 and 56. These breakaway plates 52, 54 and 56 are all integrally connected to the wall surface of the through recess 40 by means of a thin strip 58. The function of the thin strip 58 is to permit manual deflecting of the plates 52, 54 and 56 and cause such to break off. With the plates 52, 54 and 56 in position, as shown in FIG. 3, there is enclosed a 4x4 opening 60. If the breakaway plates 54 and 56 are broken away and discarded, the opening 60 will be expanded able to accommodate to a 4×6 post 10. If then the plates 52 are broken away and discarded, the opening 60 will be at its largest position and capable of accommodating a 6×6 post 10.

The present invention may be embodied in other specific forms without departing from the essential attributes thereof. Reference should be made to the appending claims rather than the foregoing specification as indicating the scope of the invention.

What is claimed is:

1. A post planter which includes:
a post shell having an exterior surface and an interior surface, said interior surface having a centrally located through recess, said recess adapted to connect with a post, an enclosed chamber located between said exterior surface and said interior surface, said enclosed chamber being open at its top and having a closed bottom, said enclosed chamber including a water chamber located adjacent said bottom and a receiving chamber located adjacent said top adapted to contain a plant growing medium, said enclosed chamber having a grate, said grate functioning to keep a plant growing medium substantially confined within said receiving chamber;
whereby a first said post shell and a second said post shell are to be located about a post with their respective said interior surfaces abutting and with plant growing medium contained within said receiving chambers, plants are to be planted therein.

2. The post planter as defined in claim 1 wherein:
said recess being of a polygonal configuration.

3. The post planter as defined in claim 1 wherein:
said recess including size adjustment means adapted to adjust to the size of the post which is mounted within said recess.

4. The post planter as defined in claim 3 wherein:
said size adjustment means including a plurality of breakaway tab plates which when broken away and removed from said recess results in said recess having a greater transverse size.

5. The post planter as defined in claim 1 wherein:
said first post shell being identical to said second post shell.

6. The post planter as defined in claim 1 wherein:
said exterior surface includes a water overfill hole, said water overfill hole being located close to said bottom but spaced therefrom.

7. The post planter as defined in claim 1 wherein:
said exterior surface having attached thereto an annular flange, said annular flange being located in substantial alignment with said bottom, said annular flange protruding exteriorly of said exterior surface, whereby said annular flange is adapted to be located on ground with said annular flange to accommodate connection with a lawnmower or trimming device in order to cut vegetation.

8. The post planter as defined in claim 1 wherein:
there being a plurality of fasteners connected between said first post shell and said second post shell thereby securing such together into a single unit.

9. The post planter as defined in claim 1 wherein:
said interior wall having a top edge located at said top, said exterior wall having an elevated arcuate lip located peripherally at said elevated top, said arcuate lip being at a higher elevation than said top edge whereby the plant growing medium is capable of being located at a level within said enclosed All chamber to be in contact with said elevated arcuate lip thereby giving the appearance that said planter is constructed as a single integral unit rather than two separate parts.
